(19) United States
(12) Patent Application Publication
(10) Pub. No.: US 2020/0234650 A1
(43) Pub. Date: Jul. 23, 2020

(54) PIXEL CIRCUIT AND CONTROL METHOD THEREOF, DISPLAY PANEL, AND DISPLAY DEVICE

(71) Applicant: Kunshan Go-Visionox Opto-Electronics Co., Ltd., Kunshan (CN)

(72) Inventors: Zhengyong ZHU, Kunshan (CN); Guohua ZHAO, Kunshan (CN); Hui ZHU, Kunshan (CN)

(21) Appl. No.: 16/841,707

(22) Filed: Apr. 7, 2020

Related U.S. Application Data
(63) Continuation of application No. PCT/CN2019/078044, filed on Mar. 13, 2019.

(30) Foreign Application Priority Data
Sep. 28, 2018 (CN) 201811140287.2

(51) Int. Cl. G09G 3/3266; G09G 3/3233

(52) U.S. Cl. CPC G09G 3/3266; G09G 2320/0233; G09G 3/3233

(57) ABSTRACT

A pixel circuit includes: nine transistors named after the first through the ninth, a capacitor, and a light emitting diode. A first electrode of the fourth transistor is connected to second electrode of third transistor, control end of first transistor and first polar plate of capacitor. A second electrode of fourth transistor is connected to second electrode of seventh transistor. A first electrode of seventh transistor is connected to anode of the light emitting diode and second electrode of the sixth transistor. A first electrode of the sixth transistor is connected to second electrode of the first transistor and first electrode of the third transistor. A second electrode is connected to first electrode of the first transistor, first electrode of the ninth transistor, and second electrode of the fifth transistor. A second electrode is connected to second polar plate of the capacitor and second electrode of the ninth transistor.

### CROSS-REFERENCES TO RELATED APPLICATIONS

This application is a continuation application of International Application

PCT/CN2019/078044, filed on Mar. 13, 2019, which claims priority to Chinese patent application No. 2018111402872, filed on Sep. 28, 2018, entitled “Pixel Circuit and Control Method Thereof, Display Panel, and Display Device”, the disclosure of both are hereby incorporated by reference in their entireties.

### TECHNICAL FIELD

The present disclosure relates to the field of display technology.

### BACKGROUND

Organic light emitting display panels are more and more applied to the field of the display technology due to their advantages of high contrast, low power consumption, wide viewing angle, and fast response speed, and the like. Generally, an organic light emitting display panel includes pixel circuits arranged in an array. The pixel circuit includes a light emitting diode D1 and a power supply. A current flowing through the light emitting diode D1 is related to a power supply voltage.

### SUMMARY

The present application provides a pixel circuit, and a control method thereof, a display panel, and a display device.

A pixel circuit includes a first transistor, a second transistor, a third transistor, a fourth transistor, a fifth transistor, a sixth transistor, a seventh transistor, an eighth transistor, a ninth transistor, a capacitor, and a light emitting diode.

A control end of the fourth transistor is configured to input a first scanning signal; a first electrode of the fourth transistor is respectively connected to a second electrode of the third transistor, a control end of the first transistor, and a first polar plate of the capacitor; a second electrode of the fourth transistor is connected to a second electrode of the seventh transistor and is configured to input a first reference voltage Vref1.

A control end of the seventh transistor is configured to input the first scanning signal, and a first electrode of the seventh transistor is respectively connected to an anode of the light emitting diode and a second electrode of the sixth transistor. A cathode of the light emitting diode is configured to input a second power supply.

A control end of the sixth transistor is configured to input a light emitting control signal, and a first electrode of the sixth transistor is respectively connected to a second electrode of the first transistor and a first electrode of the third transistor; a control end of the third transistor is configured to input a second scanning signal.

A control end of the second transistor is configured to input the second scanning signal; a first electrode of the second transistor is configured to input a data signal; a second electrode of the second transistor is respectively connected to a first electrode of the first transistor, a first electrode of the ninth transistor, and a second electrode of the fifth transistor.

A control end of the eighth transistor is configured to input a third scanning signal; a first electrode of the eighth transistor is configured to input a second reference voltage Vref2; a second electrode of the eighth transistor is respectively connected to a second polar plate of the capacitor, a second electrode of the ninth transistor; a control end of the ninth transistor is configured to input the light emitting control signal.

A control end of the fifth transistor is configured to input the light emitting control signal. A first electrode of the fifth transistor is configured to input a first power supply VDD. Optionally, a voltage value of the first reference voltage Vref1 is less than a voltage value of the second power supply.

Optionally, the first transistor, the second transistor, the third transistor, the fourth transistor, the fifth transistor, the sixth transistor, the seventh transistor, the eighth transistor and the ninth transistor are all P-type transistors or N-type transistors.

Optionally, the second transistor, the third transistor, the fourth transistor, the fifth transistor, the sixth transistor, the seventh transistor, the eighth transistor, and the ninth transistor are switching transistors, and the first transistor is a driving transistor.

Optionally, the capacitor is an energy storage capacitor and the light emitting diode is an organic light emitting diode.

Optionally, the first power supply VDD is a positive voltage and the second power supply is a negative voltage.

Optionally, a control end of each transistor is a gate of the each transistor, and a first electrode of each transistor is a source of the each transistor, and a second electrode of each transistor is a drain of the each transistor.

Optionally, the first transistor, the second transistor, the third transistor, the fourth transistor, the fifth transistor, the sixth transistor, the seventh transistor, the eighth transistor and the ninth transistor include any one of a low temperature poly-silicon thin film transistor, an oxide semiconductor thin film transistor, and an amorphous silicon thin film transistor.

A display panel includes a plurality of pixel circuits arranged in an array, in which the pixel circuit includes the aforementioned pixel circuit.

Optionally, the display panel further includes a data driver, a scanning driver and a light emitting controller, a plurality of first scanning signal lines, a plurality of second scanning signal lines, a plurality of third scanning signal lines, a plurality of data signal lines and a plurality of light emitting control signal lines.

Optionally, each row of pixel circuits is respectively connected to the scanning driver through a corresponding first scanning signal line, a corresponding second scanning signal line, and a corresponding third scanning signal line; the scanning driver provides a scanning signal and transmits the scanning signal to the pixel circuit through the scanning signal line; each column of pixel circuits is respectively connected to the data driver through a corresponding data signal line; the data driver provides a data signal and transmits the data signal to the pixel circuit through a data signal line; each row of pixel circuits is respectively connected to the light emitting controller through a corresponding light emitting control signal line; the light emitting controller provides a light emitting control signal and transmits the light emitting control signal to the pixel circuit through the light emitting control signal line.

A display device includes the aforementioned display panel.

In the above-mentioned pixel circuit, display panel and display device, the second reference voltage Vref2 is utilized to compensate the control terminal of the first transistor through a capacitor, to make the driving current flowing through the first transistor related to the second reference voltage Vref2 and independent of the first power supply VDD. Since the driving current flows through the power line, the current-resistance voltage drop on the power line has no influence on the driving current when the driving current is independent of the first power supply VDD, thereby improving the uniformity of the light emission of the screen body.

A method for driving the pixel circuit as described above includes: during an initialization phase, the first scanning signal and the third scanning signal being both low level signals, the second scanning signal and the light emitting control signal being both high level signals, the first reference voltage Vref1 and the second reference voltage Vref2 utilized to initialize the pixel circuit; during a data writing phase, the second scanning signal and the third scanning signal being both low level signals, the first scanning signal and the light emitting control signal being both high level signals, the data signal written into the pixel circuit; during a light emitting phase, the light emitting control signal being a low level signal, the first scanning signal, the second scanning signal, and the third scanning signal being high level signals, the light emitting diode emitting light.

Optionally, the first scanning signal controls the fourth transistor and the seventh transistor to switch on during the initialization phase; the first reference voltage Vref1 is utilized to initialize the first polar plate of the capacitor and the control end of the first transistor through the fourth transistor, and the first reference voltage Vref1 is utilized to initialize the anode of the light emitting diode through the seventh transistor.

Optionally, the third scanning signal controls the eighth transistor to switch on, and the second reference voltage Vref2 is utilized to initialize the second polar plate of the capacitor.

Optionally, during the data writing phase, the second scanning signal controls the second transistor to switch on, and the data signal is written into the first electrode of the first transistor through the second transistor, such that an electric potential of the first electrode of the first transistor is Vdata, and an electric potential of the control terminal of the first transistor equals to Vdata−|Vth |, in which Vth is the threshold voltage of the first transistor.

Optionally, the third scanning signal controls the eighth transistor to switch on, and the second reference voltage Vref2 is utilized to continuously initialize the second polar plate of the capacitor.

Optionally, during the light emitting phase, the light emitting control signal controls the fifth transistor and the ninth transistor to switch on. The first power supply VDD is written into the first electrode of the first transistor and the second polar plate of the capacitor; an electric potential of the first electrode of the first transistor is VDD, and an electric potential of the control end of the first transistor equals to Vdata−|Vth|+VDD−Vref2.

The method for driving the pixel circuit provided by the present disclosure compensates for the current-resistance voltage drop on the first power line by adding the second reference voltage, and also compensates for the influence of the threshold voltage on the light emitting current, thereby improving the uniformity of the light emission of the screen body.

### BRIEF DESCRIPTION OF THE DRAWINGS

FIG. 1 shows a circuit diagram illustrating a pixel circuit according to an embodiment of the present invention;

FIG. 2 shows a sequence diagram of a method for driving a pixel circuit according to an embodiment of the present invention.

### DETAILED DESCRIPTION OF THE INVENTION

In the display panel, since the distance between each light emitting diode and the power supply is different, and the voltage drop on the line generated during the voltage transmission is also different, the actual power supply voltage obtained by each light emitting diode D1 is different, the current flowing through each light emitting diode D1 is different, and the brightness of each light emitting diode D1 is also different, resulting in uneven brightness of the display panel.

In order to make the above-mentioned objective, features and advantages of the present disclosure more apparent and understandable, embodiments of the present invention will be described in detail below with reference to the accompanying drawings. Many specific details are set forth in the following description in order to fully understand the present disclosure. However, the present disclosure can be implemented in many other modes different from those described herein, and a person skilled in the art can make similar modifications without departing from the conception of the present disclosure. Therefore, the present disclosure is not limited by the specific embodiments disclosed below.

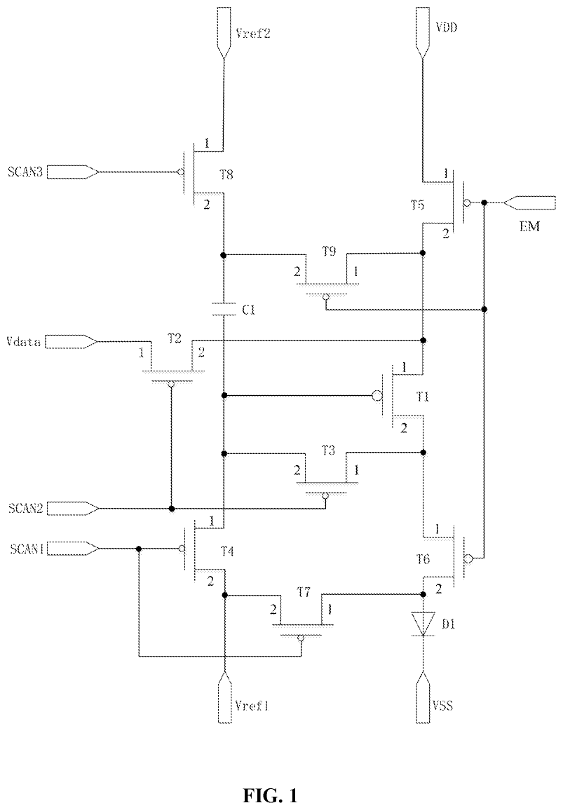

Referring to FIG. 1, a pixel circuit is provided in an embodiment of the present invention. The pixel circuit includes a first transistor T1, a second transistor T2, a third transistor T3, a fourth transistor T4, a fifth transistor T5, a sixth transistor T6, a seventh transistor T7, an eighth transistor T8, a ninth transistor T9, a capacitor C1 and a light emitting diode D1.

The pixel circuit further includes a first scanning signal input end which is respectively connected to a control end of the fourth transistor T4 and a control end of the seventh transistor T7, and is configured to input a first scanning signal SCAN1. A second scanning signal input end is respectively connected to a control end of the second transistor T2 and a control end of the third transistor T3 and is configured to input a second scanning signal SCAN2. A third scanning signal input end is connected to a control terminal of the eighth transistor T8 and is configured to input a third scanning signal SCAN3. A light emitting control signal input end is respectively connected to a control end of the fifth transistor T5, a control end of the sixth transistor T6 and a control end of the ninth transistor T9, and is configured to input a light emitting control signal EM. A data signal input end is connected to a first electrode of the second transistor T2 and is configured to input a data signal Vdata.

The control end of the fourth transistor T4 is configured to input the first scanning signal SCAN1; and a first electrode of the fourth transistor T4 is respectively connected to a second electrode of the third transistor T3, a control end of the first transistor T1, and a first polar plate of the capacitor C1. A second electrode of the fourth transistor T4 is connected to a second electrode of the seventh transistor T7; and a second electrode of the fourth transistor T4 and a second electrode of the seventh transistor T7 are configured to input a first reference voltage Vref1. The control end of the seventh transistor T7 is configured to input the first scanning signal SCAN1. A first electrode of the seventh transistor T7 is respectively connected to an anode of the light emitting diode D1 and a second electrode of the sixth transistor T6. A cathode of the light emitting diode D1 is connected to a second power supply VSS. The control end of the sixth transistor T6 is configured to input the light emitting control signal EM. A first electrode of the sixth transistor T6 is respectively connected to a second electrode of the first transistor T1 and a first electrode of the third transistor T3. The control end of the third transistor T3 is configured to input the second scanning signal SCAN2. The control end of the second transistor T2 is configured to input the second scanning signal SCAN2. The first electrode of the second transistor T2 is configured to input the data signal Vdata. The second electrode of the second transistor T2 is respectively connected to a first electrode of the first transistor T1, a first electrode of the ninth transistor T9 and a second electrode of the fifth transistor T5. The control end of the eighth transistor T8 is configured to input the third scanning signal SCAN3. A first electrode of the eighth transistor T8 is configured to input a second reference voltage Vref2. A second electrode of the eighth transistor T8 is respectively connected to a second polar plate of the capacitor C1 and a second electrode of the ninth transistor T9. The control end of the ninth transistor T9 is configured to input the light emitting control signal EM. A control end of the fifth transistor T5 is configured to input the light emitting control signal EM. A first electrode of the fifth transistor T5 is configured to input a first power supply VDD.

In the present embodiment, the second transistor T2, the third transistor T3, the fourth transistor T4, the fifth transistor T5, the sixth transistor T6, the seventh transistor T7, the eighth transistor T8, and the ninth transistor T9 are all switching transistors, while the first transistor T1 is a driving transistor. The capacitor C1 is an energy-storage capacitor, and the light emitting diode D1 is an Organic Light-Emitting Diode (OLED). The transistors in the present embodiment are all P-type transistors. Optionally, the control end is a gate of the transistor, the first electrode is a source of the transistor, and the second electrode is a drain of the transistor. A transistor can be switched on by applying a low level to the control end of the transistor. In other embodiments, the transistor may also be an N-type transistor. When the N-type transistor is used as the transistor in a pixel circuit, the transistor can be switched on by inputting a high-level signal to the control end of the transistor.

The first scanning signal SCAN1 can control the fourth transistor T4 and the seventh transistor T7 to switch on, so that the first reference voltage Vref1 initializes the gate of the first transistor T1 and the anode of the light emitting diode D1. The second scanning signal SCAN2 can control the second transistor T2 to switch on to write the data signal to the first electrode of the first transistor T1 through the second transistor T2. The third scanning signal SCAN3 can control the eighth transistor T8 to switch on to write the second reference voltage Vref2 to the second polar plate of the capacitor C1.

In the present embodiment, the first power supply VDD may be a positive voltage, and the second power supply VSS may be a negative voltage. A current can be generated under the action of the first power supply VDD by driving the first transistor T1, and the current flows through the light emitting diode D1 to cause the light emitting diode D1 to emit light. When the light emitting diode D1 emits light, the current flows from the light emitting diode D1 to the second power supply VSS.

As for the pixel circuit provided by the above embodiment, the control end of the first transistor T1 is compensated through the capacitor C1 by using the second reference voltage Vref2, to make a driving current flowing through the first transistor T1 related to the second reference voltage Vref2 while independent of the first power supply VDD. Since the driving current flows through the power line, the current-resistance voltage drop on the power line has no influence on the driving current when the driving current is independent of the first power supply VDD, thereby improving the uniformity of the light emission of the screen body.

Optionally, the first transistor T1, the second transistor T2, the third transistor T3, the fourth transistor T4, the fifth transistor T5, the sixth transistor T6, the seventh transistor T7, the eighth transistor T8, and the ninth transistor T9 may include any one of a low temperature polysilicon thin film transistor, an oxide semiconductor thin film transistor, and an amorphous silicon thin film transistor.

Optionally of the present invention, a display panel is provided, which includes a plurality of the aforementioned pixel circuits arranged in an array. The display panel further includes a data driver, a scanning driver, and a light emitting controller. One end of each of a plurality of first scanning signal lines, a plurality of second scanning signal lines and a plurality of third scanning signal lines is respectively connected to each row of pixel circuits, and the other end is connected to the scanning driver. The scanning driver provides a scanning signal and transmits the scanning signal into the pixel circuit through the scanning signal line. One end of each of a plurality of data signal lines is connected to each column of pixel circuits, and the other end is connected to the data driver. The data driver provides a data signal, and transmits the data signal to the pixel circuits through the data signal lines. One end of each of a plurality of light emitting control signal lines is connected to each row of pixel circuits, and the other end is connected to the light emitting controller. The light emitting controller provides a light emitting control signal, and transmits the light emitting control signal to the pixel circuits through the light emitting control signal lines. More specifically, each row of pixel circuits is respectively connected to the scanning driver through a corresponding first scanning signal line, a corresponding second scanning signal line, and a corresponding third scanning signal line; each column of pixel circuits is respectively connected to the data driver through a corresponding data signal line; each row of pixel circuits is respectively connected to the light emitting controller through a corresponding light emitting control signal line.

Optionally of the present invention, a display device is provided, which includes the above display panel.

Optionally of the present invention, a method for driving the aforementioned pixel circuit is provided.

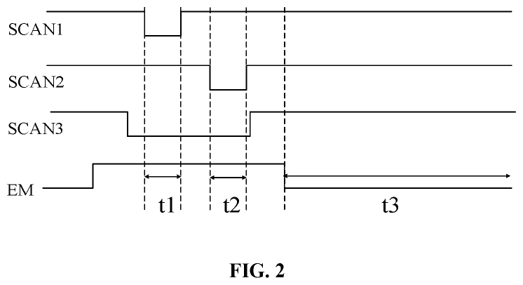

Referring to FIG. 1 and FIG. 2, FIG. 1 shows a pixel circuit provided by an embodiment of the present invention, and FIG. 2 shows a sequence signal diagram for driving the pixel circuit shown in FIG. 1. The method includes the following three stages.

During an initialization phase t1, the first scanning signal SCAN1 and the third scanning signal SCAN3 are both low level signals; the second scanning signal SCAN2 and the light emitting control signal EM are both high level signals; the first reference voltage Vref1 and the second reference voltage Vref2 are utilized to initialize the pixel circuit.

During a data writing phase t2, the second scanning signal SCAN2 and the third scanning signal SCAN3 are both low level signals; the first scanning signal SCAN1 and the light emitting control signal EM are both high level signals; the data signal is written into the pixel circuit.

During a light emitting phase t3, the light emitting control signal EM is a low level signal; the first scanning signal SCAN1, the second scanning signal SCAN2, and the third scanning signal SCAN3 are all high level signals; the light emitting diode D1 emits light.

Specifically, during the initialization phase t1, the first scanning signal SCAN1 is a low level signal, accordingly the first scanning signal SCAN1 controls the fourth transistor T4 and the seventh transistor T7 to switch on, and the first reference voltage Vref1 is utilized to initialize the first polar plate of the capacitor C1, the control end of the first transistor T1 and the anode of the light emitting diode D1. The third scanning signal SCAN3 is a low level signal, accordingly the third scanning signal SCAN3 controls the eighth transistor T8 to switch on, and the second reference voltage Vref2 is utilized to initialize the second polar plate of the capacitor C1. In the present embodiment, the first polar plate and the second polar plate of the capacitor C1 are initialized during the initialization phase t1, to keep the electric potential of the first polar plate and the electric potential of the second polar plate of the capacitor C1 respectively at the first reference voltage Vref1 and the second reference voltage Vref2. Since a light emitting current flows through the first power supply VDD, the fifth transistor T5, the first transistor T1, the sixth transistor T6, and the light emitting diode D1, to the second power supply VSS, the light emitting current does not flow through a first reference voltage line that provides the first reference voltage Vref1 and a second reference voltage line that provides the second reference voltage Vref2. Therefore, there is no current-resistance voltage drop on the first reference voltage line and the second reference voltage line, consequently the initialization state of each pixel circuit is the same, and then the uniformity of the light emission of the screen body can be better ensured.

During the data writing phase t2, the second scanning signal SCAN2 is a low level signal; the second scanning signal SCAN2 controls the second transistor T2 and the third transistor T3 to switch on; and the data signal writes a data voltage Vdata to the first electrode of the first transistor T1 through the second transistor T2, so that the electric potential of the first electrode of the first transistor T1 is Vdata. After the data voltage charges the first electrode of the first transistor T1 for a period of time, the electric potential at the control end of the first transistor T1 is maintained as Vdata−|Vth |, where Vth is a threshold voltage of the first transistor T1, accordingly the compensation for the threshold voltage of the first transistor T1 is implemented. The third scanning signal SCAN3 is also a low level signal, accordingly the third scanning signal SCAN3 can control the eighth transistor T8 to switch on, to utilize the second reference voltage Vref2 to continuously initialize the second polar plate of the capacitor C1 before the data writing ends, such that the screen body has better uniformity of the light emission.

During the light emitting phase t3, the light emitting control signal EM is a low level signal, accordingly the light emitting control signal EM controls the fifth transistor T5 and the ninth transistor T9 to switch on; and the first power supply VDD writes the power supply voltage to the first electrode of the first transistor T1 and the second polar plate of the capacitor C1. Therefore, the electric potential of the first electrode of the first transistor T1 is VDD. According to the coupling principle of capacitor, in the case where the voltage difference is constant, the electric potential of the second polar plate of the capacitor C1 is changed, and the electric potential of the first polar plate is changed accordingly. The change in the electric potential of the second polar plate of the capacitor C1 equals to VDD−Vref2, accordingly the change in the electric potential of the first polar plate of the capacitor C1 also equals to VDD−Vref2, therefore the change in the electric potential at the control end of the first transistor T1 equals to VDD−Vref2, accordingly the electric potential at the control end of the first transistor T1 equals to Vdata−|Vth|+VDD−Vref2. According to the leakage current formula of the first transistor T1, it is known that the leakage current flowing through the first transistor T1 is independent of the first power supply VDD. The leakage current flowing through the first transistor T1 is the light emitting current flowing through the light emitting diode D1, accordingly the light emitting current is independent of the first power supply VDD, thereby eliminating the influence of current-resistance voltage drop on the first power line, and improving the uniformity of the light emission of the screen body.

The working principle of the pixel circuit based on FIG. 1 and FIG. 2 is provided as follows.

During the initialization phase t1, the first scanning signal SCAN1 and the third scanning signal SCAN3 are both low level signals, and the second scanning signal SCAN2 and the light emitting control signal EM are both high level signals. The fourth transistor T4, the seventh transistor T7, and the eighth transistor T8 are switched on, while the second transistor T2, the third transistor T3, the fifth transistor T5, the sixth transistor T6, and the ninth transistor T9 are switched off.

The fourth transistor T4 is switched on, and the first reference voltage Vref1 is utilized to initialize the control end of the first transistor T1 and the first polar plate of the capacitor C1. The first reference voltage Vref1 may be a negative voltage, and the first reference voltage Vref1 is applied on the control end of the first transistor T1 to switch on the first transistor T1. The seventh transistor T7 is switched on, and the first reference voltage Vref1 is utilized to initialize the anode of the light emitting diode D1. The eighth transistor T8 is switched on, and the second reference voltage Vref2 is utilized to initialize the second polar plate of the capacitor C1, accordingly the first polar plate and the second polar plate of the capacitor C1 are both initialized. After the initialization phase, the electric potential of the first polar plate of the capacitor C1 is Vref1, and the electric potential of the second polar plate of the capacitor is Vref2.

Optionally, the voltage value of the first reference voltage Vref1 is less than the voltage value of the second power supply VSS, to ensure that the light emitting diode D1 does not emit light during the initialization. The initialization can eliminate the influence of the residual current of the previous light emitting phase on the present light emitting phase, and ensure that all the pixel circuits are in the same initialization state, which can improve the uniformity of the light emission of the screen body.

During the data writing phase t2, the second scanning signal SCAN2 and the third scanning signal SCAN3 are both low level signals, and the first scanning signal SCAN1 and the light emitting control signal EM are high level signals. The second transistor T2, the third transistor T3, and the eighth transistor T8 are switched on. During the initialization phase, the first transistor T1 has been switched on. The fourth transistor T4, the seventh transistor T7, the fifth transistor T5, the sixth transistor T6, and the ninth transistor T9 are switched off.

Since the second transistor T2 is switched on, the data signal writes the data signal voltage Vdata into the first electrode of the first transistor T1 through the second transistor T2. When the state of the circuit is stable, the electric potential of the first electrode of the first transistor T1 is Vdata, and the electric potential of the control end of the transistor T1 equals to Vdata−|Vth|, which implements the compensation for the threshold voltage of the first transistor T1. The eighth transistor T8 remains in an on state, accordingly the voltage of the second polar plate of the capacitor C1 is maintained as the second reference voltage Vref2.

During the light emitting phase t3, the light emitting control signal EM is a low level signal, while the first scanning signal SCAN1, the second scanning signal SCAN2, and the third scanning signal SCAN3 are high level signals. The fifth transistor T5, the ninth transistor T9, the sixth transistor T6 and the first transistor T1 are switched on, while the fourth transistor T4, the seventh transistor T7, the second transistor T2, the third transistor T3, and the eighth transistor T8 are switched off.

Since the fifth transistor T5 and the ninth transistor T9 are switched on, the power supply voltage of the first power supply VDD is written to the first electrode of the first transistor T1 and the second polar plate of the capacitor C1, such that the electric potential of the first electrode of the first transistor T1 is VDD, and the electric potential of the second polar plate of the capacitor C1 is VDD. Since the third transistor T3 and the fourth transistor T4 are switched off, and the capacity of the capacitor C1 is much larger than the parasitic capacitance of other transistors, the voltage difference of the capacitor C1 does not change. Since the electric potential of the second polar plate of the capacitor C1 is changed from Vref2 in the data writing phase t2 to VDD in the light emitting phase t3, the amount of changes equals to VDD−Vref2. According to the coupling principle of the capacitor, in the case where the voltage difference of the capacitor C1 remains constant, the electric potential of the first polar plate of the capacitor C1 is also changed with the changes of the second polar plate, and the electric potential of the first polar plate of the capacitor C1 is the electric potential of the control end of the first transistor T1, then the electric potential of the control end of the first transistor T1 equals to Vdata−|Vth|+VDD−Vref2. Therefore, the gate-to-source voltage of the first transistor T1 satisfies the formula: Vgs=Vdata−|Vth|+VDD −Vref2−VDD=Vdata−|Vth|−Vref2, and the driving current flowing through the first transistor T1 satisfies the following formula:

I=K*(Vgs−Vth)²=K*(Vdata−|Vth|−Vref2+|Vth|)²=K*(Vdata−Vref2)².

Where, K=½*μ*Cox*W/L ·μ is an electron mobility of the first transistor T1, Cox is a gate oxide capacitance per unit area of the first transistor T1, W is a channel width of the first transistor T1, and L is a channel length of the first transistor T1. The driving current flowing through the first transistor T1 is the light emitting current flowing through the light emitting diode D1. It can be seen from the above formula that the light emitting current flowing through the light emitting diode D1 is independent of the voltage of the first power supply VDD, and is also independent of the threshold voltage of the transistor, meanwhile the light emitting current does not flow through the second reference voltage line. Therefore, the circuit structure and the method for driving the circuit provided by the embodiments of the present invention compensate for the current-resistance voltage drop on the first power line by adding the second reference voltage. Meanwhile, the circuit structure and the method for driving the circuit of the present disclosure also compensate for the influence of the threshold voltage on the light emitting current, thereby improving the uniformity of the light emission of the screen body.

Each technical feature of the above-described embodiments can be combined arbitrarily. For brevity of the description, not all the possible combinations of the technical features in the above embodiments are described herein. However, all of the combinations of these technical features should be considered as within the scope of the present disclosure, as long as there is no contradiction in the combinations of these technical features.

The above embodiments merely illustrate several exemplary embodiments of the disclosure, and the description thereof is specific and detailed, but they are not constructed as limiting the scope of the disclosure. A number of variations and improvements made by those skilled in the art without departing from the conception of the disclosure are within the protection scope of the present disclosure. The protection scope of the present disclosure shall be subject to the appended claims.

1. A pixel circuit comprising: a first transistor, a second transistor, a third transistor, a fourth transistor, a fifth transistor, a sixth transistor, a seventh transistor, an eighth transistor, a ninth transistor, a capacitor, and a light emitting diode;
wherein:
a control end of the fourth transistor is configured to input a first scanning signal, a first electrode of the fourth transistor is respectively connected to a second electrode of the third transistor, a control end of the first transistor, and a first polar plate of the capacitor, a second electrode of the fourth transistor is connected to a second electrode of the seventh transistor and is configured to input a first reference voltage Vref1;
a control end of the seventh transistor is configured to input the first scanning signal, a first electrode of the seventh transistor is respectively connected to an anode of the light emitting diode and a second electrode of the sixth transistor, a cathode of the light emitting diode is configured to input a second power supply;
a control end of the sixth transistor is configured to input an light emitting control signal, a first electrode of the sixth transistor is respectively connected to a second electrode of the first transistor and a first electrode of the third transistor, a control end of the third transistor is configured to input a second scanning signal;
a control end of the second transistor is configured to input the second scanning signal, a first electrode of the second transistor is configured to input a data signal, a second electrode of the second transistor is respectively connected to a first electrode of the first transistor, a first electrode of the ninth transistor, and a second electrode of the fifth transistor;
a control end of the eighth transistor is configured to input a third scanning signal, a first electrode of the eighth transistor is configured to input a second reference voltage Vref2, a second electrode of the eighth transistor is respectively connected to a second polar plate of the capacitor and a second electrode of the ninth transistor, a control end of the ninth transistor is configured to input the light emitting control signal; and
a control end of the fifth transistor is configured to input the light emitting control signal, a first electrode of the fifth transistor is configured to input a first power supply VDD.

2. The pixel circuit according to claim 1, wherein a voltage value of the first reference voltage Vref1 is less than a voltage value of the second power supply.

3. The pixel circuit according to claim 1, wherein the first transistor, the second transistor, the third transistor, the fourth transistor, the fifth transistor, the sixth transistor, the seventh transistor, the eighth transistor and the ninth transistor are all P-type transistors or are all N-type transistors.

4. The pixel circuit according to claim 1, wherein the second transistor, the third transistor, the fourth transistor, the fifth transistor, the sixth transistor, the seventh transistor, the eighth transistor, and the ninth transistor are all switching transistors, and the first transistor is a driving transistor.

5. The pixel circuit according to claim 1, wherein the capacitor is an energy storage capacitor and the light emitting diode is an organic light emitting diode.

6. The pixel circuit according to claim 1, wherein the first power supply VDD is a positive voltage and the second power supply is a negative voltage.

7. The pixel circuit according to claim 1, wherein a control end of each transistor is a gate of the each transistor, and a first electrode of each transistor is a source of the each transistor, and a second electrode of each transistor is a drain of the each transistor.

8. The pixel circuit according to claim 1, wherein the first transistor, the second transistor, the third transistor, the fourth transistor, the fifth transistor, the sixth transistor, the seventh transistor, the eighth transistor and the ninth transistor comprise any one of a low temperature poly-silicon thin film transistor, an oxide semiconductor thin film transistor, and an amorphous silicon thin film transistor.

9. A display panel, comprising a plurality of pixel circuits arranged in an array, wherein the pixel circuit comprises the pixel circuit according to claim 1.

10. The display panel according to claim 9, further comprising a data driver, a scanning driver and a light emitting controller, a plurality of first scanning signal lines, a plurality of second scanning signal lines, a plurality of third scanning signal lines, a plurality of data signal lines and a plurality of light emitting control signal lines.

11. The display panel according to claim 10, wherein,
each row of pixel circuits is respectively connected to the scanning driver through a corresponding first scanning signal line, a corresponding second scanning signal line and a corresponding third scanning signal line; the scanning driver provides a scanning signal and transmits the scanning signal to the pixel circuit through a scanning signal line;
each column of pixel circuits is respectively connected to the data driver through a corresponding data signal line; the data driver provides a data signal and transmits the data signal to the pixel circuit through a data signal line;
each row of pixel circuits is respectively connected to the light emitting controller through a corresponding light emitting control signal line; the light emitting controller provides a light emitting control signal and transmits the light emitting control signal to the pixel circuit through the light emitting control signal line.

12. A display device, comprising the display panel of claim 9.

13. A method for driving the pixel circuit of claim 1, comprising:
during an initialization phase, a first scanning signal and a third scanning signal being both low level signals, a second scanning signal and a light emitting control signal being both high level signals, a first reference voltage Vref1 and a second reference voltage Vref2 utilized to initialize the pixel circuit;
during a data writing phase, the second scanning signal and the third scanning signal being both low level signals, the first scanning signal and the light emitting control signal being both high level signals, a data signal written into the pixel circuit; and
during a light emitting phase, the light emitting control signal being a low level signal, and the first scanning signal, the second scanning signal, and the third scanning signal being high level signals, the light emitting diode emitting light.

14. The method for driving the pixel circuit according to claim 13, wherein during the initialization phase, the first scanning signal controls the fourth transistor and the seventh transistor to switch on; and
the first reference voltage Vref1 is utilized to initialize the first polar plate of the capacitor and the control end of the first transistor through the fourth transistor, and the first reference voltage Vref1 is utilized to initialize the anode of the light emitting diode through the seventh transistor.

15. The method for driving the pixel circuit according to claim 14, wherein the third scanning signal controls the eighth transistor to switch on, and the second reference voltage Vref2 is utilized to initialize the second polar plate of the capacitor.

16. The method for driving the pixel circuit according to claim 15, wherein during the data writing phase, the second scanning signal controls the second transistor to switch on, and the data signal is written to the first electrode of the first transistor through the second transistor, an electrode potential of the first electrode of the first transistor is Vdata, and an electric potential of the control end of the first transistor equals to Vdata−|Vth|, wherein Vth is a threshold voltage of the first transistor.

17. The method for driving the pixel circuit according to claim 16, wherein the third scanning signal controls the eighth transistor to switch on, and the second reference voltage Vref2 is utilized to continuously initialize the second polar plate of the capacitor.

18. The method for driving the pixel circuit according to claim 17, wherein during the light emitting phase, the light emitting control signal controls the fifth transistor and the ninth transistor to switch on, the first power supply VDD is written to the first electrode of the first transistor and the second polar plate of the capacitor, an electric potential of the first electrode of the first transistor is VDD, and an electric potential of the control end of the first transistor equals to Vdata−|Vth|+VDD−Vref2.
